(19) United States
(12) Patent Application Publication
(10) Pub. No.: US 2025/0330213 A1
(43) Pub. Date: Oct. 23, 2025

(54) NEAR FIELD COMMUNICATION DEVICE

(71) Applicant: Samsung Electronics Co., Ltd., Suwon-si (KR)

(72) Inventors: Nyeongmin Kwon, Suwon-si (KR); Seokyeong Kwon, Suwon-si (KR); Seokhyun Kim, Suwon-si (KR)

(21) Appl. No.: 18/932,957

(22) Filed: Oct. 31, 2024

(30) Foreign Application Priority Data
Apr. 18, 2024 (KR) 10-2024-0052068

(51) Int. Cl. H04B 5/20

(52) U.S. Cl. CPC H04B 5/20

(57) ABSTRACT

An NFC device including an amplifier outputting a TX signal to an antenna, a phase detector comparing a phase of a recovery clock signal generated by an RX signal transmitted to the antenna with a phase of a reference clock signal to calculate a phase difference, and a clock generator outputting a transmission clock signal to the amplifier, and controlling a phase of the transmission clock signal with reference to the calculated phase difference. When a field emitted by an external reader is sensed, the clock generator outputs a pre-clock signal having a random phase to the amplifier to emit a pre-TX signal before receiving the RX signal from the reader. The phase detector transmits, to the clock generator, an initial phase difference calculated by comparing a phase of a reflected clock signal recovered from a reflected signal of the pre-TX signal with the phase of the reference clock signal.

### CROSS-REFERENCE TO RELATED APPLICATION(S)

This application claims the benefit of priority under 35 U.S.C. § 119 to Korean Patent Application No. 10-2024-0052068 filed on Apr. 18, 2024, in the Korean Intellectual Property Office, the disclosure of which is incorporated herein by reference in its entirety.

### BACKGROUND

Aspects of the present inventive concept relate to a near field communication (NFC) device.

A NFC technique may be a communication technology that may exchange data within a short distance using a frequency in a specific bandwidth, and may be applied to various fields due to advantages thereof, such as high security or the like. Recently, near field communication devices for providing NFC functions have been installed in various types of electronic devices, and mobile devices may use the NFC functions to provide users with electronic payment functions and data exchange functions, such as transportation cards, credit cards, coupons, or the like. In order to use the NFC functions, initial settings may be required for smooth communications between a device operating in reader mode and a device operating in card (e.g., card emulation) mode, and several methods have been proposed to proceed with the initial settings quickly and accurately.

### SUMMARY

An aspect of the present inventive concept is to provide an NFC device emitting a pre-transmit (pre-TX) signal before first receiving a receive (RX) signal from an external device operating in reader mode, and setting an initial value of a radio frequency (RF) parameter using a reflected signal of the pre-TX signal.

According to an aspect of the present inventive concept, an NFC device includes an amplifier configured to output a TX signal to an antenna; a phase detector configured to compare a phase of a recovery clock signal generated by an RX signal transmitted to the antenna with a phase of a reference clock signal, to calculate a phase difference; and a clock generator configured to output a transmission clock signal to the amplifier, and control a phase of the transmission clock signal with reference to the phase difference calculated by the phase detector, wherein, when a field emitted by an external reader is detected, the clock generator outputs a pre-clock signal having a random phase to the amplifier to emit a pre-TX signal from the amplifier, before receiving the RX signal from the external reader, and the phase detector transmits, to the clock generator, an initial phase difference calculated by comparing a phase of a reflected clock signal recovered from a reflected signal of the pre-TX signal received at the antenna with the phase of the reference clock signal.

According to an aspect of the present inventive concept, an NFC device includes a clock generator configured to generate a pre-clock signal having a random phase, when entry into a field generated by an external device is detected; an amplifier configured to transmit a pre-TX signal through an antenna in response to the pre-clock signal; and a phase detector, when a reflected signal of the pre-TX signal is received by the antenna, configured to compare a reflected clock signal generated by the reflected signal and a predetermined reference clock signal to calculate an initial phase difference, wherein the clock generator adjusts an RF parameter including at least one of a frequency or phase of a first TX signal first transmitted to the external device, with reference to the initial phase difference.

According to an aspect of the present inventive concept, an NFC device includes an antenna configured to transmit a TX signal to an external device and receive an RX signal from the external device; an amplifier configured to output the TX signal to the antenna; and a clock generator configured to output a transmission clock signal corresponding to the TX signal to the amplifier, before receiving the RX signal from the external device, wherein the clock generator adjusts an RF parameter including at least one of a frequency or phase of the transmission clock signal after transmitting the TX signal to the antenna and before receiving the RX signal from the external device.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a view illustrating an electronic device including an NFC device according to an embodiment.

FIG. 2 is a block diagram illustrating an NFC device according to an embodiment.

FIG. 3 is a flowchart illustrating an operation of an NFC device according to an embodiment.

FIG. 4 is a flowchart illustrating an operation of an NFC device according to an embodiment.

FIG. 5 is a view illustrating an operation of an NFC device according to an embodiment.

FIG. 6 is a view illustrating an operation of an NFC device according to an embodiment.

FIG. 7 is a view illustrating an NFC device according to an embodiment.

FIG. 8 is a view illustrating an operation of an NFC device according to an embodiment.

FIGS. 9 and 10 are views illustrating an operation of an NFC device according to an embodiment.

FIGS. 11 to 13 are views illustrating an operation of an NFC device according to an embodiment.

FIG. 14 is a view illustrating a time-to-digital converter included in an NFC device according to an embodiment.

FIG. 15 is a block diagram illustrating an electronic device including an NFC device according to an embodiment.

### DETAILED DESCRIPTION

Hereinafter, preferred embodiments of the present inventive concept will be described with reference to the attached drawings.

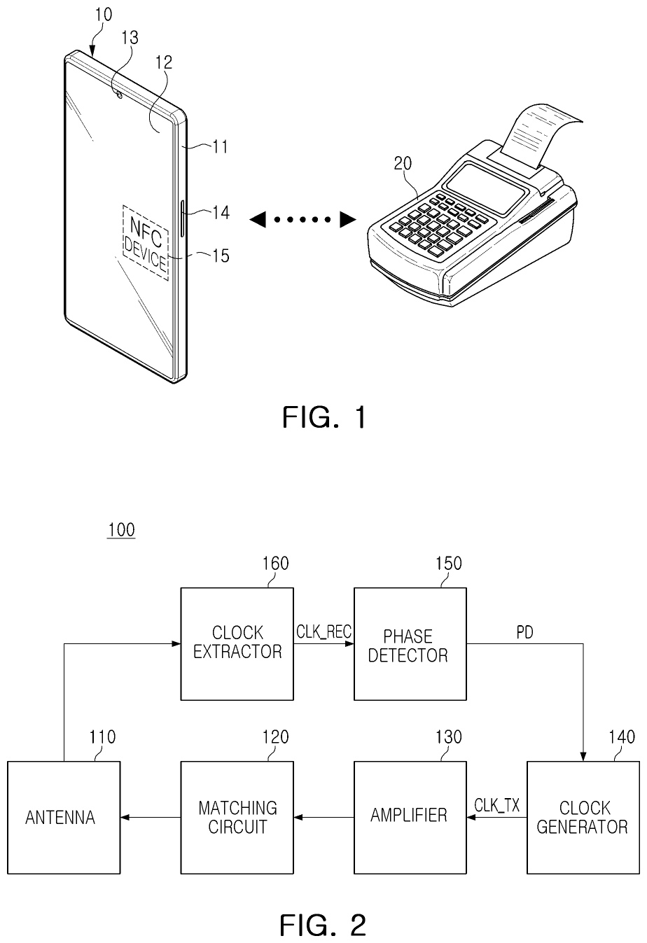

FIG. 1 is a view illustrating an electronic device including an NFC device according to an embodiment.

Referring to FIG. 1, an electronic device 10 according to an embodiment may include a housing 11, a display 12, a camera unit 13, an input unit 14, a near field communication (NFC) device 15, and the like. Although the electronic device 10 is illustrated as being a smartphone, the NFC device 15 according to an embodiment may also be applied to various other devices such as a desktop computer, a home TV, a set-top box, an appliance (e.g., refrigerator, a washing machine, a dryer, an air conditioner etc.), or the like, as well as a mobile device such as a tablet PC, a laptop computer, or the like.

The NFC device 15 included in the electronic device 10 may communicate with an external device 20 using a wireless signal within a specific frequency band. As illustrated in FIG. 1, when the external device 20 is a device operating in reader mode, the NFC device 15 may operate in card mode. When the external device is an NFC tag, the NFC device 15 may operate in reader mode as a reader for the NFC tag.

When the NFC device 15 operates in card mode, the NFC device 15 may communicate with the external device 20 operating in reader mode using a wireless signal in a specific frequency band, for example, 13.56 MHz. When a radio frequency (RF) field caused by a signal emitted by the external device 20 is detected in card mode, the NFC device 15 may proceed with initial setting of an RF parameter required for communication with the external device 20. For example, the RF parameter may include a frequency, a phase, or the like of a clock signal generated by the NFC device 15.

With respect to conventional NFC technology, in the initial setting of the RF parameter by the NFC device 15, an arbitrary value may be used, or a value stored in a memory in a table or the like may be used. When the initial setting of the RF parameter is completed, the NFC device 15 may emit a transmit (TX) signal with the initially set RF parameter after receiving an RX signal from the external device 20. When the initial setting of the RF parameter is performed in the above manner, it is not possible to cover all actual communication environments to which the NFC device 15 is exposed, and ultimately, communication may not be established because the external device 20 does not properly recognize the TX signal emitted by the NFC device 15 after the initial setting of the RF parameters.

In accordance with aspects of the present invention, when the NFC device 15 operating in card mode senses the RF field generated by the external device 20, a pre-TX signal (e.g., a “first TX signal” or an “initial TX signal”) for the initial setting of the RF parameter may be emitted. For example, the pre-TX signal may be emitted first, before receiving a first RX signal from the external device 20.

When the pre-TX signal is emitted, a reflected signal thereof may enter into the NFC device 15. The NFC device 15 may extract a recovery clock signal from the reflected signal, and may compare the recovery clock signal with the reference clock signal to determine the frequency, the phase, or the like for the initial setting of the RF parameter. Therefore, the RF parameter may be initially set according to characteristics of the RF field generated by the external device 20 with which actual communication will be performed, and communication performance between the NFC device 15 and the external device 20 may be improved.

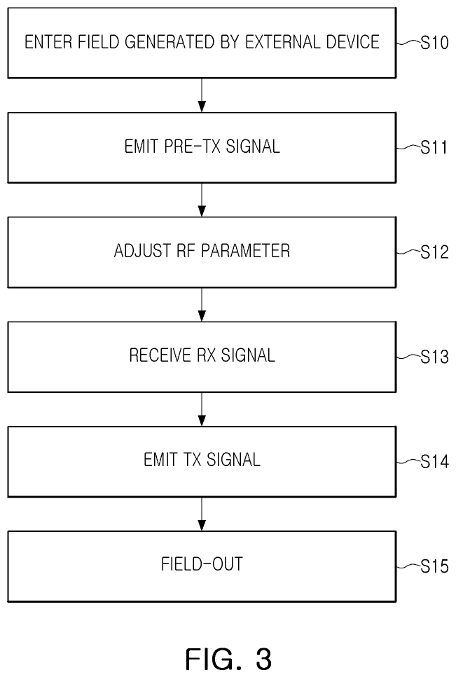

FIG. 2 is a block diagram illustrating an NFC device according to an embodiment.

Referring to FIG. 2, an NFC device 100 according to an embodiment may include an antenna 110, a matching circuit 120, an amplifier 130, a clock generator 140, a phase detector 150, a clock extractor 160, and the like. In an embodiment, the NFC device 100 may be mounted in the electronic device 10, and may receive power from a power supply device of the electronic device 10 to operate in card mode and reader mode.

The antenna 110 may be connected to the matching circuit 120, and may emit a TX signal externally in response to a signal output by the amplifier 130. For example, the amplifier 130 may emit a TX signal externally through the antenna 110 in response to a transmission clock signal CLK_TX output by the clock generator 140. The TX signal emitted through the antenna 110 may include data to be transmitted to the external device 20. For example, data may be included in the TX signal by modulating the TX signal using an active load modulation (LMA) manner, and may be released externally.

When the external device 20 generates an RF field and emits a signal, an RX signal may enter into the antenna 110 by induction of a magnetic field. The clock extractor 160 may extract a recovery clock signal CLK_REC having a predetermined frequency and a predetermined phase from the RX signal introduced into the antenna 110. For example, characteristics such as the frequency and the phase of the recovery clock signal CLK_REC generated by the clock extractor 160 may be determined according to the RX signal entering into the antenna 110.

The phase detector 150 may compare the recovery clock signal CLK_REC with a predetermined reference clock signal. For example, the reference clock signal may be generated by a phase-locked loop circuit or the like included in the NFC device 100 or included in the electronic device 10 together with the NFC device 100. The phase detector 150 may compare the phase of the recovery clock signal CLK_REC with a phase of the reference clock signal to calculate a phase difference PD, and may transmit the phase difference PD to the clock generator 140.

The clock generator 140 may adjust a phase of the transmission clock signal CLK_TX with reference to the phase difference PD received from the phase detector 150. For example, the clock generator 140 may advance or delay the phase of the transmission clock signal CLK_TX previously output to the amplifier 130 with reference to the phase difference PD. In this manner, the phase of the transmission clock signal CLK_TX may be adjusted using the phase difference PD calculated by the phase detector 150, to improve communication performance between the NFC device 100 and the external device 20.

In an operation of the NFC device 100, the RX signal may be received from the external device 20 through the antenna 110, the recovery clock signal CLK_REC may be extracted from the RX signal to generate the phase difference PD, and then the clock generator 140 may output the transmission clock signal CLK_TX to the amplifier 130. For example, after the NFC device 100 first receives the RX signal from the external device 20 in one communication cycle, the NFC device 100 may emit the TX signal to the external device.

In an embodiment, under conditions after the NFC device 100 enters the RF field generated by the external device 20, the NFC device 100 may first emit the TX signal before receiving the RX signal from the external device 20. The TX signal emitted first before the NFC device 100 receives the RX signal may be defined as a pre-TX signal, and may be a signal emitted for initial setting of an RF parameter of the NFC device 100, not for communication with the external device.

For example, the RF parameter configured using the pre-TX signal may include a frequency, a phase, or the like of the transmission clock signal CLK_TX output by the clock generator 140. When the pre-TX signal is emitted through the antenna 110, a reflected signal of the pre-TX signal may flow back into the antenna 110. The reflected signal of the pre-TX signal may result in part based on the RF field generated by the external device 20. The clock extractor 160 may generate the recovery clock signal CLK_REC from the reflected signal, may detect the phase difference PD between the recovery clock signal CLK_REC and the reference clock signal, and may transmit the detected phase difference PD to the clock generator 140. The phase difference PD transmitted to the clock generator 140 after emitting the pre-TX signal may be an initial phase difference for initial setting of the RF parameter.

The reflected signal of the pre-TX signal may be changed depending on characteristics of the RF field generated by the external device 20. Unlike a method of selecting one of pre-stored values to initialize the RF parameter, the initial setting of the RF parameter may be performed by reflecting characteristics of the RF field used for actual communication of the NFC device 100, to improve quality of a first TX signal emitted by the NFC device 100 for communication with the external device 20. Therefore, communication probability between the NFC device 100 and the external device may increase, and communication performance therebetween may be improved.

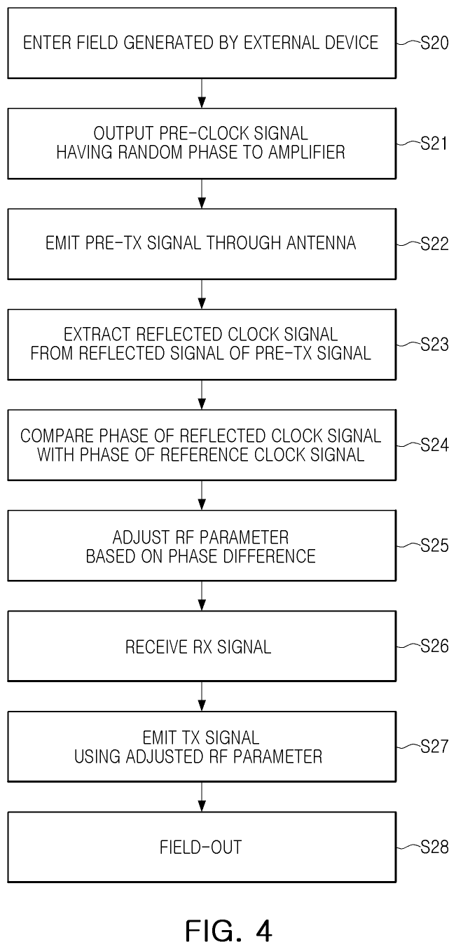

Referring to FIG. 3, an operation of an NFC device according to an embodiment may begin with entering a field generated by an external device and sensing the field by the NFC device (S10). The external device may be a device operating in reader mode, and may emit an RF signal externally to generate the field.

When the field is detected by the NFC device, the NFC device may first emit a pre-TX signal (S11). The pre-TX signal emitted by the NFC device may be a signal emitted first by the NFC device operating in card mode before receiving the signal from the external device. For example, the NFC device may input a pre-clock signal to an amplifier connected to an antenna through a matching circuit to emit the pre-TX signal through the antenna.

A frequency and a phase of the pre-clock signal input to the amplifier to emit the pre-TX signal may be determined in various manners. In an embodiment, the NFC device may determine the frequency and the phase of the pre-clock signal according to predetermined settings.

Once the pre-TX signal is emitted, the NFC device may adjust an RF parameter (S12). For example, as the NFC device adjusts an RF parameter, at least one of a frequency or a phase of a transmission clock signal input to the amplifier may be changed. When the RF parameter is adjusted, the NFC device may receive an RX signal from the external device through the field generated by the external device (S13). The NFC device may demodulate the RX signal to receive data transmitted by the external device.

The NFC device may emit a TX signal to transmit a response to the RX signal to the external device (S14). The TX signal may include the response to the RX signal and the data to be transmitted to the external device. The transmission clock signal may be input to the amplifier such that the NFC device may emit a TX signal, and the frequency and/or phase of the transmission clock signal may be determined by the RF parameters adjusted previously in S12. Afterwards, field-out of the NFC device may be performed to terminate communication with the external device (S15). According to an embodiment, the receiving an RX signal from the external device (S13) and the emitting the TX signal in response to the RX signal (S14) may be repeated multiple times.

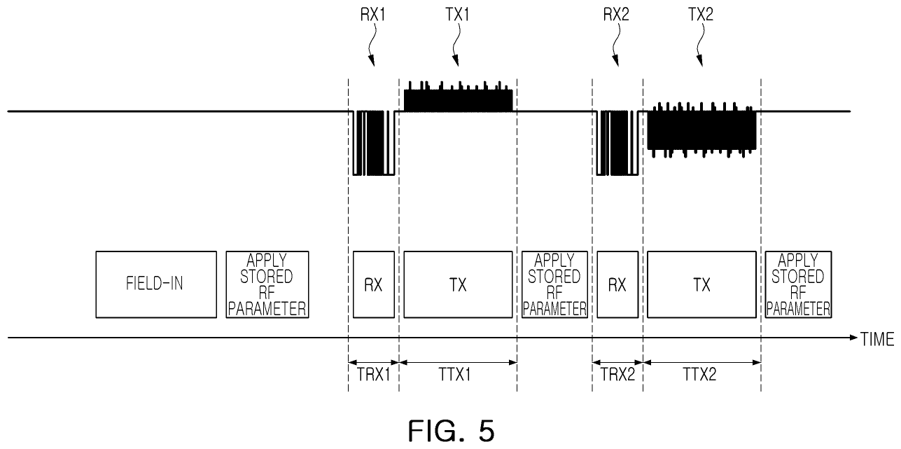

Referring to FIG. 4, an operation of an NFC device according to an embodiment may begin with entering a field generated by an external device and sensing the field by the NFC device (S20). Similar to the embodiment previously described with reference to FIG. 3, the external device may be a device operating in a reader mode that generates the field by emitting an RF signal.

When the field is detected, the NFC device may first output a pre-clock signal having a first phase to an amplifier (S21). The first phase of the pre-clock signal may be a phase that is randomly selected and may be referred to herein as a “random phase.” The amplifier may amplify the pre-clock signal, and may transmit the same to an antenna, and, therefore, a pre-TX signal may be emitted through the antenna (S22). When the pre-TX signal is emitted through the antenna, a reflected signal of the pre-TX signal may return to the NFC device. An analog signal may be generated at the antenna by the reflected signal returned to the

NFC device. A clock extractor connected to the antenna in the NFC device may extract a reflected clock signal from the analog signal that the antenna generates in response to the reflected signal (S23). Once the reflected clock signal is extracted, a phase detector may compare a phase of the reflected clock signal with a phase of a reference clock signal (S24). For example, the reference clock signal may be a clock signal generated by the NFC device or by a separate circuit included in an electronic device equipped with the NFC device.

When a phase difference between the reflected clock signal and the reference clock signal is detected, the NFC device may adjust an RF parameter, based on the phase difference (S25). For example, in S24, the phase difference between the reflected clock signal and the reference clock signal sensed by the phase detector may be an initial phase difference obtained by emitting the pre-TX signal before the NFC device communicates with the external device. The NFC device may adjust the RF parameter determining characteristics of a TX signal to be emitted for communication with the external device, with reference to the initial phase difference.

When the RF parameter is adjusted, the NFC device may receive an RX signal from the external device through the field generated by the external device (S26). The NFC device may emit the TX signal in response to the RX signal. In an embodiment, a clock generator included in the NFC device may output a transmission clock signal to the amplifier, and the amplifier may amplify the transmission clock signal, and may input the same to the antenna, to emit the TX signal from the antenna.

In an embodiment, the NFC device may emit the TX signal using the RF parameter adjusted in S25 (S27). For example, in the adjusting the RF parameter in S25, at least one of a frequency, a phase, or an amplitude of the transmission clock signal transmitted from the clock generator to the amplifier may be adjusted. Therefore, the RF parameter adjusted in S25 may be reflected in the TX signal emitted by the amplifier through the antenna. Afterwards, field-out of the NFC device may be performed to terminate communication

with the external device (S28). According to an embodiment, the receiving an RX signal from the external device (S26) and the emitting the TX signal in response to the RX signal (S27) may be repeated multiple times. In this case, during a time period after emitting the TX signal and before receiving the RX signal again, the NFC device may readjust the RF parameter, as necessary.

As described with reference to FIGS. 3 and 4, in an embodiment, an NFC device operating in card mode may first emit a pre-TX signal, prior to receiving a first RX signal from an external device operating in reader mode and generating a field, and based thereon, an RF parameter may be adjusted. Therefore, the RF parameter may be adjusted in consideration of actual communication environments, including strength of the field generated by the external device, and the first TX signal may be emitted based thereon, to improve reliability of communication between the NFC device and the external device, and to increase communication therebetween.

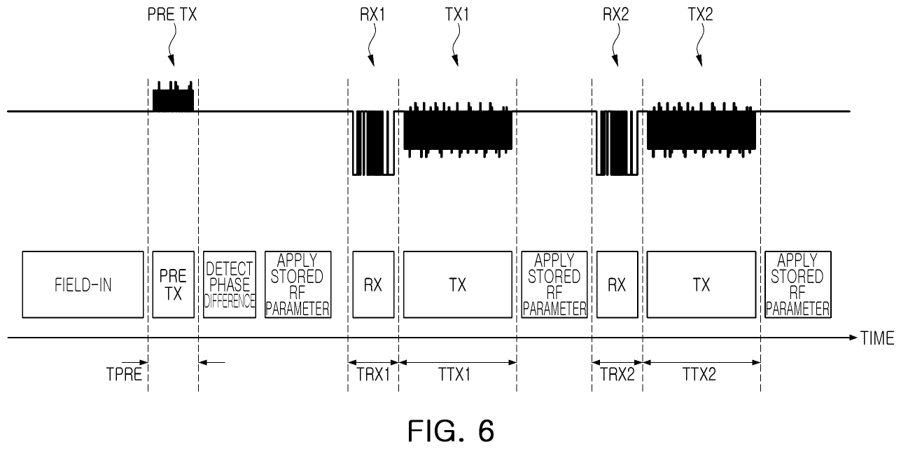

Referring to FIG. 5, an NFC device may enter a space affected by a field generated by an external device, may sense the field, and may apply a stored RF parameter. Information for initial setting of an RF parameter may be stored in a memory inside or outside the NFC device, and when the field generated by the external device is detected, the NFC device may complete the initial setting of the RF parameter, based on the information read from the memory.

Thereafter, the NFC device may receive a first RX signal RX1 from the external device during a first reception time TRX1. Subsequent to receiving the first RX signal RX1, the NFC device may emit a first TX signal TX1 based on the RF parameter set based on the information read from the memory before the first reception time TRX1. The first TX signal TX1 may be transmitted during a first transmission time TTX1 after the first reception time TRX1.

The first TX signal TX1 transmitted with the RF parameter set based on the information obtained from the memory may not be suitable for transmitting data to the external device through the field generated by the external device, and therefore, after the first transmission time TTX1, the NFC device may further adjust the RF parameter. Thereafter, in a second reception time TRX2, the NFC device may receive a second RX signal RX2 from the external device, and may transmit a second TX signal TX2 in response to the second RX signal RX2 during a second transmission time TTX2. When the second transmission time TTX2 ends, an operation of adjusting the RF parameter may be performed again.

In this manner, when the NFC device performs the initial setting of RF parameter based on pre-stored information and first receives the first RX signal RX1 from the external device, compatibility of the first TX signal TX1 transmitted for the first time by the NFC device, with the external device, may not be sufficiently secured. For example, a phase error may occur because a phase of the first TX signal TX1 does not match a phase of the external device, which may reduce reliability of communication between the NFC device and the external device.

The RF parameter affecting compatibility of the TX signals TX1 and TX2 transmitted from the NFC device and the external device may also be changed, depending on not only strength of the field formed by the external device, but also characteristics of the antenna, a matching circuit, and the like included in a transmission path of the TX signals TX1 and TX2 from the NFC device. Since the compatibility of the TX signals TX1 and TX2 and the external device varies depending on a design and a manufacturing process of the NFC device, as well as the field generated by the external device in actual use environments, there may be bound to be limits to optimizing the initial setting of the RF parameter only with the information previously stored in the memory.

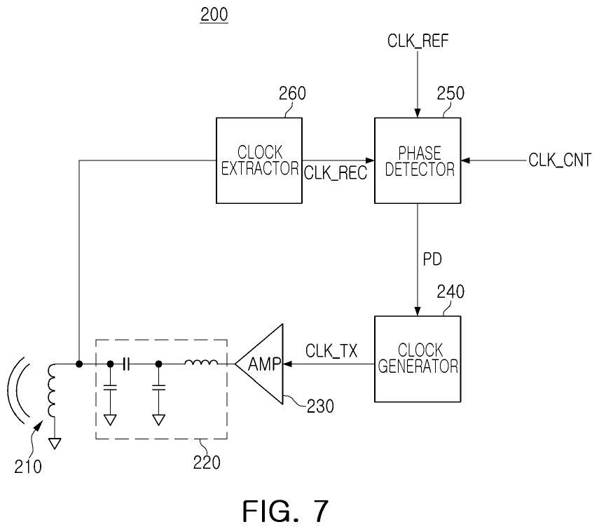

As illustrated in the embodiment of FIG. 6, instead of using the information stored in the memory, the NFC device may emit a pre-TX signal before receiving the first RX signal RX1 from the external device, and may use a reflected signal thereof, to execute the initial setting of the RF parameter. Therefore, quality of the first TX signal TX1 transmitted to the external device as a response to the first RX signal RX1 may be improved to allow smooth communication between the NFC device and the external device.

Referring to FIG. 6, an operation of an NFC device according to an embodiment may begin with entering a space affected by a field generated by an external device and sensing the field by the NFC device. When the field is detected, the NFC device may transmit a pre-TX signal PRE-TX during a pre-transmission time TPRE, instead of initializing an RF parameter using information stored in a memory. For example, a pre-clock signal generated inside the NFC device may be input to an amplifier, and the amplifier may amplify the pre-clock signal and output the same to an antenna. Therefore, the pre-TX signal may be transmitted through the antenna. The pre-transmission time TPRE may be shorter than a first transmission time TTX1 at which a first TX signal TX1 is transmitted.

When the pre-TX signal is transmitted, a reflected signal of the pre-TX signal may flow back into the antenna. Therefore, an analog signal corresponding to the reflected signal may be output from the antenna, and the NFC device may extract a reflected clock signal corresponding to the reflected signal from the analog signal. The reflected clock signal may have a predetermined frequency and a predetermined phase, and the NFC device may compare a phase of the reflected clock signal with a phase of a reference clock signal to detect an initial phase difference.

The NFC device may adjust the RF parameter based on the initial phase difference. In an embodiment illustrated in FIG. 6, a phase of the first TX signal TX1 that may be initially transmitted to the external device may be determined by the initial phase difference. Therefore, the RF parameter may be adjusted using the reflected clock signal in which characteristics of the field generated by the external device to communicate with the NFC device and characteristics of the antenna, a matching circuit, or the like, mounted on the NFC device are reflected, and quality of the first TX signal TX1 may be improved.

For example, the phase of the reflected clock signal may be affected by the field generated by the external device. A phase of a transmission clock signal input to the amplifier during the first transmission time TTX1 based on the initial phase difference calculated by comparing the phase of the reflected clock signal with the phase of the reference clock signal may be adjusted to sufficiently ensure compatibility between the first TX signal TX1 and the external devices, and improve reliability and accuracy of communication therebetween.

As illustrated in FIG. 6, in an embodiment, the NFC device may operate by first transmitting a pre-TX signal before receiving an RX signal from the external device. For example, before receiving a first RX signal RX1, the pre-TX signal PRE-TX may be transmitted through the antenna, and before receiving a second RX signal RX2, the first TX signal TX1 may be transmitted through the antenna. In addition, the NFC device may adjust the RF parameter determining a frequency, a phase, or the like of a transmission clock signal for transmitting the first TX signal TX1 during the time after transmitting the pre-TX signal PRE-TX through the antenna and before receiving the first RX signal RX1 from the external device.

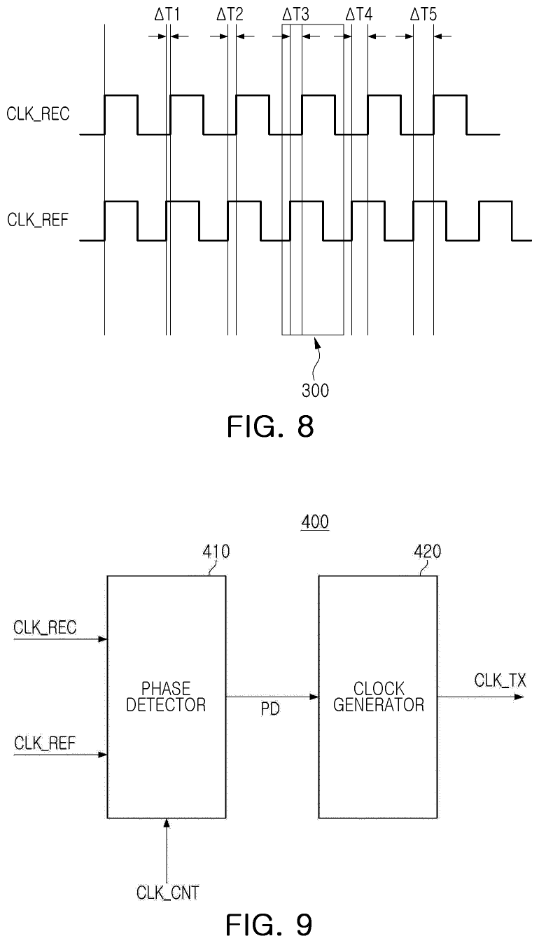

FIG. 7 is a view illustrating an NFC device according to an embodiment.

Referring to FIG. 7, an NFC device 200 according to an embodiment may include an antenna 210, a matching circuit 220, an amplifier 230, a clock generator 240, a phase detector 250, a clock extractor 260, and the like. The amplifier 230 may amplify a transmission clock signal CLK_TX received from the clock generator 240, and may output the same to the matching circuit 220. The matching circuit 220 may perform impedance matching on a signal output by the amplifier 230, may transmit the same to the antenna 210, and may emit a TX signal externally from the antenna 210.

The matching circuit 220 may include at least one inductor element and at least one capacitor element. Depending on an embodiment, the matching circuit 220 may also be connected between the antenna 210 and the clock extractor 260. The antenna 210 may generate an analog signal in response to an RF signal flowing in

from the outside. The analog signal may be transmitted to the clock extractor 260, and the clock extractor 260 may extract a recovery clock signal CLK_REC from the analog signal. In an embodiment, the analog signal may be a signal having a sinusoidal waveform, and the clock extractor 260 may generate the recovery clock signal CLK_REC that may be a square wave signal from the analog signal.

The recovery clock signal CLK_REC may be input to the phase detector 250. The phase detector 250 may compare a phase of the recovery clock signal CLK_REC with a phase of a reference clock signal CLK_REF. For example, the reference clock signal CLK_REF may be a clock signal generated by the NFC device 200 or a phase-locked loop circuit included in an electronic device equipped with the NFC device 200.

The phase detector 250 may use a count clock signal CLK_CNT to count a difference between the phase of the recovery clock signal CLK_REC and the phase of the reference clock signal CLK_REF. A frequency of the count clock signal CLK_CNT may be faster than a frequency of the recovery clock signal CLK_REC and a frequency of the reference clock signal CLK_REF. In an embodiment, the frequency of the recovery clock signal CLK_REC and the frequency of the reference clock signal CLK_REF may be about 13.56 MHz, respectively, and the frequency of the count clock signal CLK_CNT may be several hundred MHz. In an embodiment, the phase detector 250 may count a time between a rising edge of the recovery clock signal CLK_REC and a rising edge of the reference clock signal CLK_REF as the count clock signal CLK_CNT to calculate a phase difference PD, and may transmit the phase difference PD to the clock generator 240.

The clock generator 240 may adjust a phase of the transmission clock signal CLK_TX with reference to the phase difference PD. In an embodiment, the transmission clock signal CLK_TX may be generated by controlling the phase of the recovery clock signal CLK_REC or the phase of the reference clock signal CLK_REF with reference to the phase difference PD. The transmission clock signal CLK_TX may be input to the amplifier 230, and as described above, the amplifier 230 may amplify the transmission clock signal CLK_TX, and may apply the same to the matching circuit 220 and the antenna 210.

In an embodiment, before receiving a first RX signal from the external device, the NFC device 200 may first emit a pre-TX signal through the antenna 210. When the pre-TX signal is emitted, some thereof may return as a reflected signal, and flow back into the NFC device 200 through the antenna 210. The antenna 210 may send an analog signal corresponding to the reflected signal to the clock extractor 260, and the clock extractor 260 may extract a reflected clock signal from the reflected signal, and may send the same to the phase detector 250 as the recovery clock signal CLK_REC.

The phase detector 250 may compare a phase of the reflected clock signal received as the recovery clock signal CLK_REC with the phase of the reference clock signal CLK_REF. As described above, the phase detector 250 may count a delay time between the reflected clock signal and the reference clock signal CLK_REF using the count clock signal CLK_CNT having a relatively short cycle, to calculate the phase difference PD, and may send the same to the clock generator 240.

The clock generator 240 may adjust the phase of the transmission clock signal CLK_TX with reference to the phase difference PD calculated by the phase detector 250. Therefore, before receiving the first RX signal from the external device, an operation of optimizing the TX signal transmitted by the NFC device 200 to suit communication environments may first be completed, and quality of the first TX signal may be improved to improve accuracy and reliability of communication between the NFC device 200 and the external device.

The phase detector 250 may calculate the phase difference PD in various manners. As previously explained, the count clock signal CLK_CNT having a fast frequency may be used to calculate the phase difference PD corresponding to the delay time between the rising edge of the recovery clock signal CLK_REC and the rising edge of the reference clock signal CLK_REF. Additionally, a time-to-digital converter for calculating a delay time between the recovery clock signal CLK_REC and the reference clock signal CLK_REF, which may be difficult to determine from the count clock signal CLK_CNT, may be included in the phase detector 250.

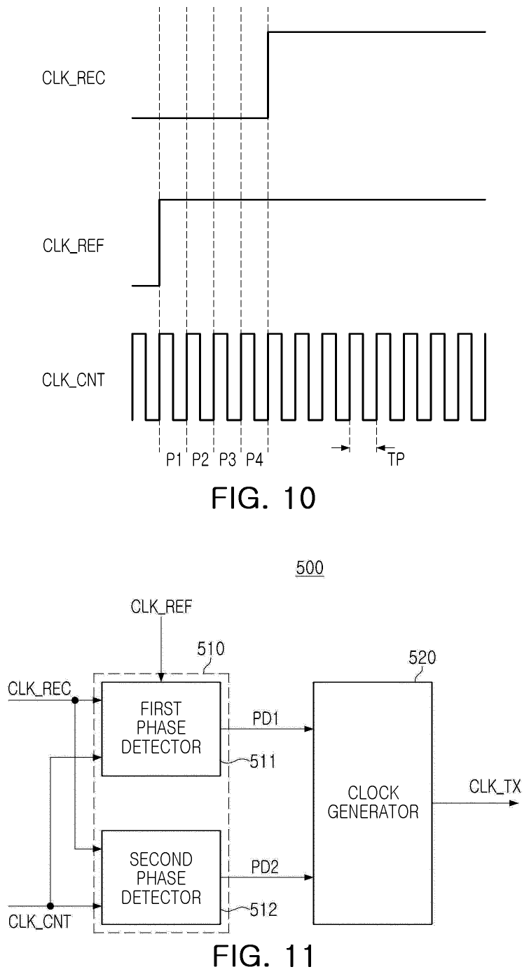

FIG. 8 is a view illustrating an operation of an NFC device according to an embodiment.

FIG. 8 may be a view illustrating a recovery clock signal CLK_REC and a reference clock signal CLK_REF, input to a phase detector of an NFC device according to an embodiment. In an embodiment, while the reference clock signal CLK_REF generated by a phase-locked loop circuit has a constant cycle, each cycle of the recovery clock signal CLK_REC may not be fixed, and may increase or decrease. Therefore, a phase difference may appear between the reference clock signal CLK_REF and the recovery clock signal CLK_REC.

In an embodiment illustrated in FIG. 8, a cycle of the recovery clock signal CLK_REC may be shorter than a cycle of the reference clock signal CLK_REF. Therefore, as illustrated in FIG. 8, a clock delay time (ΔT1 to ΔT5) may appear between a rising edge of the reference clock signal CLK_REF and a rising edge of the recovery clock signal CLK_REC.

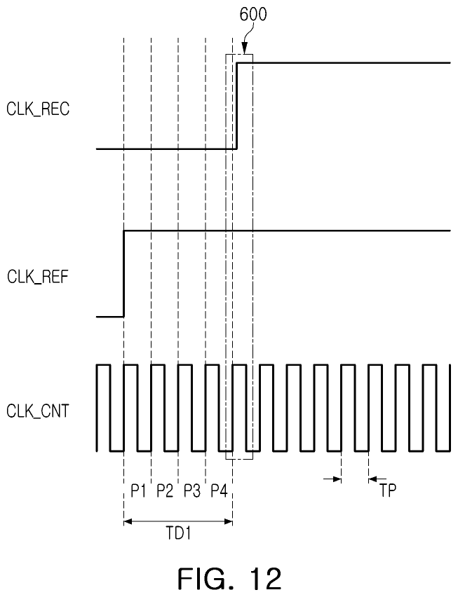

As previously described with reference to FIG. 7, the NFC device may include the phase detector comparing the recovery clock signal CLK_REC and the reference clock signal CLK_REF to calculate the phase difference. In an embodiment, the phase detector may receive the recovery clock signal CLK_REC and the reference clock signal CLK_REF, and may count the clock delay time (ΔT1 to ΔT5) between the rising edge of the recovery clock signal CLK_REC and the rising edge of the reference clock signal CLK_REF as a separate count clock signal. Hereinafter, with reference to FIGS. 9 and 10, a method for calculating a phase difference based on a third clock delay time ΔT3 in the highlighted section 300 of FIG. 8 will be described in more detail.

FIGS. 9 and 10 are views illustrating an operation of an NFC device according to an embodiment.

Referring to FIG. 9, an NFC device 400 according to an embodiment may include a phase detector 410, a clock generator 420, and the like. The phase detector 410 may receive a recovery clock signal CLK_REC, a reference clock signal CLK_REF, and a count clock signal CLK_CNT, and may send a phase difference PD to the clock generator 420. The clock generator 420 may control a phase of a transmission clock signal CLK_TX based on the phase difference PD, and may then output the same to an amplifier.

FIG. 10 may be an enlarged view of section 300 in an embodiment, as previously described with reference to FIG. 8. Referring to FIGS. 8 and 10 together, a rising edge of a recovery clock signal CLK_REC may be later than a rising edge of a reference clock signal CLK_REF by a third clock delay time ΔT3. A cycle TP of a count clock signal CLK_CNT may be shorter than a cycle of the recovery clock signal CLK_REC and a cycle of the reference clock signal CLK_REF, respectively. In an embodiment, the cycle of the recovery clock signal CLK_REC and the cycle of the reference clock signal CLK_REF may be several tens of ns, respectively, and the cycle TP of the count clock signal CLK_CNT may be several ns.

In an embodiment illustrated in FIG. 10, first to fourth cycles P1 to P4 of the count clock signal CLK_CNT may be included during the third clock delay time ΔT3. Therefore, a phase detector 410 may output a phase difference PD corresponding to count number 4 calculated based on the count clock signal CLK_CNT to a clock generator 420. The clock generator 420 may adjust a phase of a pre-clock signal output to an amplifier

to emit a pre-TX signal, with reference to the phase difference PD corresponding to the third clock delay time ΔT3 including the first to fourth cycles P1 to P4. For example, the clock generator 420 may inversely reflect the phase difference PD into the pre-clock signal to generate a transmission clock signal for a TX signal transmitted to an external device. In an embodiment illustrated in FIG. 10, the clock generator 420 may advance the phase of the pre-clock signal by the third clock delay time ΔT3 indicated by the phase difference PD, to generate the transmission clock signal.

According to an embodiment, the clock delay time (ΔT1 to ΔT5) between the recovery clock signal CLK_REC and the reference clock signal CLK_REF may not be accurately counted as a multiple of one cycle TP of the count clock signal CLK_CNT. In this case, as described with reference to FIGS. 9 and 10, the phase difference PD between the recovery clock signal CLK_REC and the reference clock signal CLK_REF may not be accurately calculated by using only the count clock signal CLK_CNT.

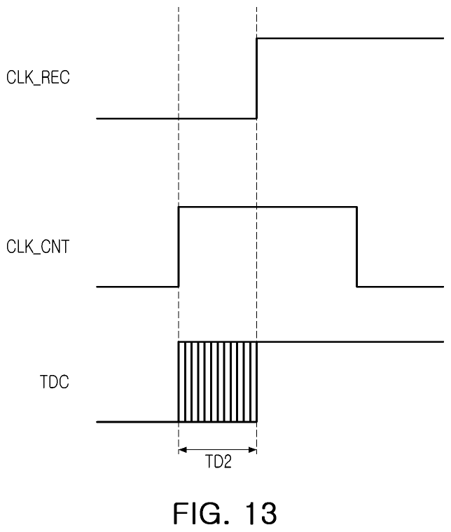

In an embodiment, the phase detector 410 of the NFC device 400 may detect the phase difference PD, due to a delay time, shorter than the cycle TP of the count clock signal CLK_CNT. Hereinafter, it will be described in more detail with reference to FIGS. 11 to 13.

FIGS. 11 to 13 are views illustrating an operation of an NFC device according to an embodiment.

Referring to FIG. 11, an NFC device 500 according to an embodiment may include a phase detector 510, a clock generator 520, and the like. The phase detector 510 may include a first phase detector 511 and a second phase detector 512, and a recovery clock signal CLK_REC and a count clock signal CLK_CNT may be input to the first phase detector 511 and the second phase detector 512, respectively.

In addition to the recovery clock signal CLK_REC and the count clock signal CLK_CNT, a reference clock signal CLK_REF may be further input to the first phase detector 511. As described above, the reference clock signal CLK_REF may have a fixed cycle, and a cycle of the recovery clock signal CLK_REC may be changed depending on communication environments or the like. The count clock signal CLK_CNT may have a cycle shorter than the cycle of the recovery clock signal CLK_REC and a cycle of the reference clock signal CLK_REF.

As previously described with reference to FIGS. 9 and 10, the first phase detector 511 may provide a first phase difference PD1 corresponding to a result of counting the clock delay time between the recovery clock signal CLK_REC and the reference clock signal CLK_REF with the count clock signal CLK_CNT, to the clock generator 520. For example, the first phase difference PD1 may correspond to an integer portion of a phase difference between the recovery clock signal CLK_REC and the reference clock signal CLK_REF.

The second phase detector 512 may not receive the reference clock signal CLK_REF. The second phase detector 512 may include a time-to-digital converter TDC, and may provide a second phase difference PD2 corresponding to a clock delay time between the recovery clock signal CLK_REC and the count clock signal CLK_CNT, to the clock generator 520. The second phase difference PD2 may be generated as a multiple of a unit delay time, shorter than the cycle of the count clock signal CLK_CNT, and therefore the second phase difference PD2 may correspond to a decimal portion of the phase difference between the recovery clock signal CLK_REC and the reference clock signal CLK_REF.

Referring to FIGS. 11 and 12 together, a rising edge of the recovery clock signal CLK_REC may be later than a rising edge of the reference clock signal CLK_REF. A cycle TP of the count clock signal CLK_CNT may be shorter than the cycle of the recovery clock signal CLK_REC and the cycle of the reference clock signal CLK_REF, respectively. In an embodiment illustrated in FIG. 12, during a time between the rising edge of the recovery clock signal CLK_REC and the rising edge of the reference clock signal CLK_REF, first to fourth cycles P1 to P4 of the count clock signal CLK_CNT may be included. The first phase detector 511 may calculate a first delay time TD1 based on the count clock signal CLK_CNT, and the clock generator 520 may provide the first phase difference PD1 corresponding to the first delay time TD1.

In an embodiment illustrated in FIG. 12, a delay time between the rising edge of the recovery clock signal CLK_REC and the rising edge of the reference clock signal CLK_REF may not match a multiple of one cycle TP of the count clock signal CLK_CNT. Referring to FIG. 12, in a section 600 including the rising edge of the recovery clock signal CLK_REC, an end point of a fourth cycle P4 may not coincide with the rising edge of the recovery clock signal CLK_REC. Therefore, the first phase difference PD1 alone may not accurately represent a phase difference between the recovery clock signal CLK_REC and the reference clock signal CLK_REF.

In an embodiment illustrated in FIG. 11, the second phase detector 512 may calculate a second delay time TD2 excluding the first delay time TD1 from the delay time between the rising edge of the recovery clock signal CLK_REC and the rising edge of the reference clock signal CLK_REF. The second phase detector 512 may include a time-to-digital converter. Referring to FIG. 13, the second delay time TD2 may be counted as a unit delay time, shorter than one cycle TP of the count clock signal CLK_CNT, and a second phase difference PD2 corresponding to the second delay time TD2 may be provided to the clock generator 520.

The clock generator 520 may inversely reflect the first phase difference PD1 and the second phase difference PD2 to a transmission clock signal CLK_TX to adjust a phase of the transmission clock signal CLK_TX. For example, the transmission clock signal CLK_TX may advance by a clock delay time that may be the sum of the first delay time TD1 defined by the first phase difference PD1 and the second delay time TD2 defined by the second phase difference PD2.

The phase of the transmission clock signal CLK_TX may be adjusted with reference to the first phase difference PD1 calculated in units of the cycle TP of the count clock signal CLK_CNT, and the second phase difference PD2 calculated by a unit delay time, shorter than the cycle TP of the count clock signal CLK_CNT, to generate the transmission clock signal CLK_TX optimized for communication environments of the NFC device 500. In this manner, the first phase difference PD1 may be calculated at relatively low resolution using the count clock signal CLK_CNT, and the second phase difference PD2 may be calculated at high resolution using the time-to-digital converter, to increase accuracy of phase difference detection and effectively manage power consumption of the NFC device 500.

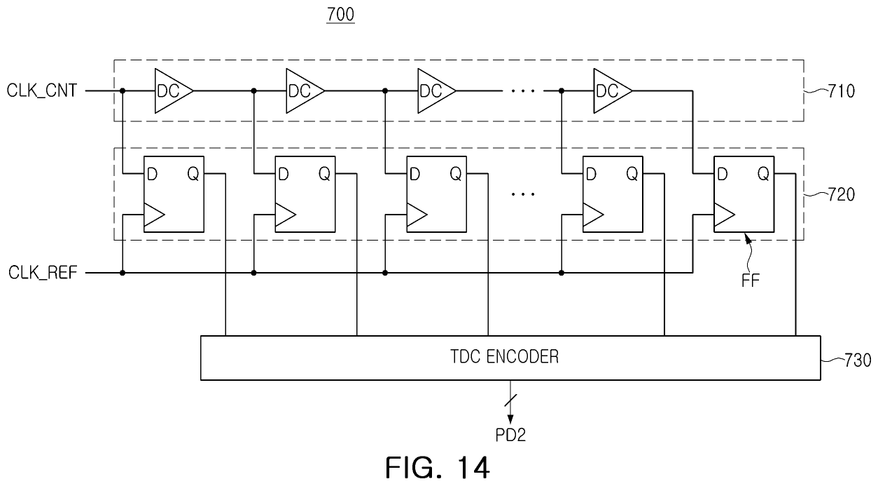

FIG. 14 is a view illustrating a time-to-digital converter included in an NFC device according to an embodiment.

As previously described, a phase detector may include a time-to-digital converter capable of detecting a second phase difference PD2 having a resolution higher than a cycle of a count clock signal. Referring to FIG. 14, a time-to-digital converter 700 included in a phase detector may include a plurality of delay cells 710, a plurality of flip-flops 720, a TDC encoder 730, and the like.

The plurality of delay cells 710 may be connected in series, and may receive a count clock signal CLK_CNT. Each of the plurality of delay cells 710 may have a predetermined unit delay time. For example, the unit delay time of each of the plurality of delay cells 710 may be tens of ps.

An input terminal of each of the plurality of flip-flops 720 may be connected to an input terminal of each of the plurality of delay cells 710, and an output terminal of each of the plurality of flip-flops 720 may be connected to the TDC encoder 730. The plurality of flip-flops 720 may operate in synchronization with a reference clock signal CLK_REF. The TDC encoder 730 may output a second phase difference PD2 obtained by encoding outputs of the plurality of flip-flops 730 into digital signals. The number of bits of the second phase difference PD2 may be determined depending on the number of the plurality of flip-flops 720.

The number of the plurality of delay cells 710 and the number of the plurality of flip-flops 720 may be determined according to a unit delay time of each of the plurality of delay cells 710 and one cycle of the count clock signal CLK_CNT. For example, the number of the plurality of delay cells 710 may be equal to the number of the plurality of flip-flops 720, and the number of the plurality of delay cells 710 may be a value divided by one cycle of the count clock signal CLK_CNT by the unit delay time of each of the plurality of delay cells 710.

Referring to FIG. 13 for convenience of explanation, the count clock signal CLK_CNT may be delayed by a unit delay time by the plurality of delay cells 710, to be input to the plurality of flip-flops 720. In the example illustrated in FIG. 13, among the plurality of flip-flops 720, 12 flip-flops may output ‘1,’ and remaining flip-flops may output ‘0.’

In embodiments described with reference to FIGS. 9 to 14, an NFC device (400 and 500) may transmit a pre-TX signal before receiving a first RX signal from an external device, and may use a reflected signal of the pre-TX signal to be applied to initial setting of an RF parameter. For example, in the NFC device 500 such as an embodiment illustrated in FIG. 11, a clock generator 520 may output a transmission clock signal CLK_TX for transmitting the pre-TX signal, prior to receiving the first RX signal from the external device, to an amplifier. A frequency and/or a phase of the transmission clock signal CLK_TX for transmitting the pre-TX signal may be arbitrarily determined.

When the pre-TX signal is transmitted externally, the reflected signal thereof may flow back into the NFC device 500. A clock extractor of the NFC device 500 may generate a recovery clock signal CLK_REC from the reflected signal, and may provide the same to a phase detector 510. A first phase detector 511 may count a phase difference between the recovery clock signal CLK_REC and a reference clock signal CLK_REF as a count clock signal CLK_CNT, to calculate a first phase difference PD1. A second phase detector 512 may include a time-to-digital converter 700 calculating a second phase difference PD2 corresponding to a phase difference between the recovery clock signal CLK_REC and the count clock signal CLK_CNT.

A resolution of the first phase difference PD1 may be determined according to a cycle TP of the count clock signal CLK_CNT, and a resolution of the second phase difference PD2 may be determined according to each unit delay time of a plurality of delay cells 710 included in the time-to-digital converter 700. With reference to the first phase difference PD1 detected in relatively high resolution and the second phase difference PD2 detected in relatively low resolution, a clock generator 520 may adjust the frequency and/or the phase of the transmission clock signal CLK_TX.

Before the NFC device 500 receives the first RX signal from the external device, the NFC device 500 may adjust an RF parameter for generating the transmission clock signal CLK_TX with reference to the first phase difference PD1 and the second phase difference PD2. Therefore, after the NFC device 500 receives the first RX signal, quality of a first TX signal transmitted to the external device in response thereto may be improved, and accuracy and reliability of communication between the NFC device 500 and the external device may be improved.

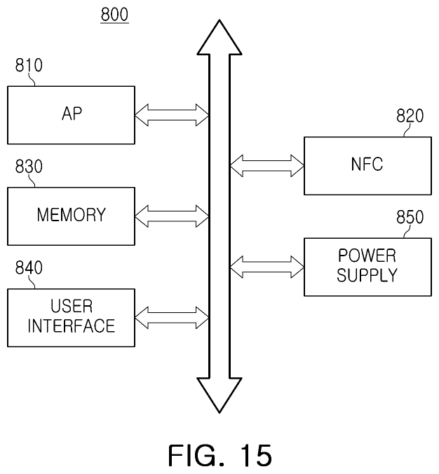

FIG. 15 is a block diagram illustrating an electronic device including an NFC device according to an embodiment.

Referring to FIG. 15, an electronic device 800 may include an application processor (AP) 810, an NFC device 820, a memory device 830, a user interface 840, a power supply unit 850, and the like. For example, the electronic device 800 may be a mobile phone, a smartphone, a personal digital assistant (PDA), a portable multimedia player (PMP), a digital camera, a music player, a portable game console, a navigation system, a laptop computer, or the like.

The application processor 810 may control an overall operation of the electronic device 800. The application processor 810 may execute applications that provide an internet browser, a game, video playback, image capturing, or the like. The application processor 810 may include one processor core (single core) or may include a plurality of processor cores (multi-core). The application processor 810 may include a cache memory device that temporarily stores an instruction or data stored in the memory device 830.

The memory device 830 may store data necessary for an operation of the electronic device 800. As an example, the memory device 830 may include a volatile memory device and/or a non-volatile memory device. The volatile memory device may be implemented as a DRAM, an SRAM, a mobile DRAM, or a memory similar thereto, and the non-volatile memory device may be implemented as an electrically erasable programmable read only memory (EEPROM), a flash memory, a phase change RAM (PRAM), a resistance RAM (RRAM), a nano floating gate memory (NFGM), a polymer RAM (PoRAM), a magnetic RAM (MRAM), a ferroelectric RAM (FRAM), or a memory similar thereto. For example, the memory device 830 may store a boot image for booting the electronic device 800, and may store output data to be transmitted to, and input data received from an external device.

The NFC device 820 may transmit data provided by the application processor 810 and/or the memory device 830 to the external device through NFC communication, and may receive data received from the external device to provide the same to the application processor 810 and/or the memory device 830. For example, the NFC device 820 may be implemented according to embodiments of the present inventive concept described in FIGS. 1 to 14. To improve quality of communication with the external device, the NFC device 820 may emit the pre-TX signal before receiving the first RX signal from the external device, and may compare the reflected clock signal recovered from the reflected signal with the reference clock signal, to adjust the RF parameter for setting the first TX signal.

The user interface 840 may include one or more input devices, such as a keypad or a touch screen, and/or one or more output devices, such as a speaker or a display device. The power supply unit 850 may supply an operating voltage of the electronic device 800. Additionally, the electronic device 800 may further include a camera image processor (CIS), a modem such as a baseband chipset, or the like. For example, the modem may be a modem processor that supports communications such as GSM, GPRS, WCDMA, HSxPA, or the like. According to an embodiment, after sensing a field generated by an external device, and

before first receiving an RX signal from the external device, a pre-TX signal may be emitted first from an NFC device. The NFC device may receive a reflected signal of the pre-TX signal to generate a recovery clock signal, and may compare a phase of a pre-clock signal input to an amplifier that emitted the pre-TX signal with a phase of the recovery clock signal, to perform initial setting of an RF parameter. Therefore, the RF parameter may be set accurately, and communication performance between the NFC device and the external device may be improved.

Various advantages and effects of the present inventive concept are not limited to the above-described contents, and can be more easily understood through descriptions of specific embodiments of the present inventive concept.

While example embodiments have been illustrated and described above, it will be apparent to those skilled in the art that modifications and variations could be made without departing from the scope of the present inventive concept as defined by the appended claims.

What is claimed is:

1. A near field communication (NFC) device comprising:
an amplifier configured to output a transmit (TX) signal to an antenna;
a phase detector configured to compare a phase of a recovery clock signal generated by a receive (RX) signal transmitted to the antenna with a phase of a reference clock signal to calculate a phase difference; and
a clock generator configured to output a transmission clock signal to the amplifier, and control a phase of the transmission clock signal with reference to the phase difference calculated by the phase detector,
wherein, when a field emitted by an external reader is detected, the clock generator outputs a pre-clock signal having a random phase to the amplifier to emit a pre-TX signal from the amplifier before receiving the RX signal from the external reader, and
the phase detector transmits, to the clock generator, an initial phase difference calculated by comparing a phase of a reflected clock signal recovered from a reflected signal of the pre-TX signal received at the antenna with the phase of the reference clock signal.

2. The NFC device of claim 1, wherein, when the phase detector detects the initial phase difference and receives the RX signal from the external reader, the clock generator controls the phase of the transmission clock signal based on the initial phase difference.

3. The NFC device of claim 1, further comprising:
a matching circuit connected between an output terminal of the amplifier and the antenna.

4. The NFC device of claim 1, wherein the phase detector compares the phase of the reflected clock signal and the phase of the reference clock signal, while an active load modulation operation is activated, to detect the initial phase difference.

5. The NFC device of claim 1, wherein the phase detector calculates the initial phase difference using a count clock signal having a cycle shorter than a cycle of the reference clock signal.

6. The NFC device of claim 5, wherein the phase detector comprises a first phase detector calculating a first component of the initial phase difference as a multiple of the cycle of the count clock signal, and a second phase detector calculating a second component of the initial phase difference as a multiple of a unit delay time shorter than the cycle of the count clock signal.

7. The NFC device of claim 6, wherein the second phase detector is a time-to-digital converter including a plurality of delay cells, each of the plurality of delay cells having a delay time equal to the unit delay time.

8. The NFC device of claim 6, wherein the first component is determined by a number of times in which the cycle of the count clock signal is repeated during a clock delay time between a rising edge of the recovery clock signal and a rising edge of the reference clock signal.

9. The NFC device of claim 8, wherein the second component is determined by a number of times in which the unit delay time is repeated after the last cycle of the count clock signal included in the clock delay time and before the rising edge of the recovery clock signal arrives.

10. The NFC device of claim 6, wherein the first component is an integer portion of the initial phase difference, and the second component is a decimal portion of the initial phase difference.

11. A near field communication (NFC) device comprising:
a clock generator configured to generate a pre-clock signal having a random phase when entry into a field generated by an external device is detected;
an amplifier configured to transmit a pre-transmit (TX) signal through an antenna in response to the pre-clock signal; and
a phase detector, when a reflected signal of the pre-TX signal is received by the antenna, configured to compare a reflected clock signal generated by the reflected signal and a predetermined reference clock signal to calculate an initial phase difference,
wherein the clock generator adjusts a radio frequency (RF) parameter including at least one of a frequency or phase of a first TX signal first transmitted to the external device with reference to the initial phase difference.

12. The NFC device of claim 11, wherein the initial phase difference comprises a first phase difference and a second phase difference, and
the phase detector detects the first phase difference with a first resolution, and detects the second phase difference with a second resolution higher than the first resolution.

13. The NFC device of claim 11, wherein the phase detector compares a recovery clock signal, generated by a signal received by the antenna after transmitting the first TX signal, with the predetermined reference clock signal to adjust the RF parameter to be applied to a second TX signal transmitted to the external device after transmitting the first TX signal.

14. The NFC device of claim 11, wherein the phase detector receives the reflected clock signal, the predetermined reference clock signal, and a count clock signal having a cycle shorter than a cycle of the reflected clock signal and a cycle of the predetermined reference clock signal.

15. The NFC device of claim 14, wherein a transmission time of the pre-TX signal is shorter than a transmission time of the first TX signal.

16. The NFC device of claim 11, further comprising:
a matching circuit connected between the amplifier and the antenna, and including at least one capacitor element and at least one inductor element.

17. The NFC device of claim 11, wherein the clock generator generates a transmission clock signal for the first TX signal by inversely reflecting a clock delay time defined by the initial phase difference to the pre-clock signal.

18. A near field communication (NFC) device comprising:
an antenna configured to transmit a transmit (TX) signal to an external device and receive a receive (RX) signal from the external device;
an amplifier configured to output the TX signal to the antenna; and
a clock generator configured to output a transmission clock signal corresponding to the TX signal to the amplifier before receiving the RX signal from the external device,
wherein the clock generator adjusts a radio frequency (RF) parameter including at least one of a frequency or phase of the transmission clock signal after transmitting the TX signal to the antenna and before receiving the RX signal from the external device.

19. The NFC device of claim 18, wherein the RX signal is a first RX signal first received from the external device.

20. The NFC device of claim 19, wherein a phase of the transmission clock signal output from the clock generator to the amplifier, before receiving the first RX signal from the external device, is randomly determined.
